(19) United States
(12) Patent Application Publication
(10) Pub. No.: US 2003/0124229 A1
(43) Pub. Date: Jul. 3, 2003

(54) Plastic container for dry solid food

(76) Inventors: Kenichi Hama, Tokyo (JP); Tsuyoshi Kage, Tokyo (JP)

Correspondence Address: James V Costigan, Hedman & Costigan, 1185 Avenue of the Americas, New York, NY, 10036-2646, US

(21) Appl. No.: 10/182,942

(22) PCT Filed: Feb. 22, 2001
(86) PCT No.: PCT/JP01/01297

(30) Foreign Application Priority Data
Feb. 24, 2000 (JP) 2000-48389

(51) Int. Cl. C12C 1/027

(52) U.S. Cl. 426/106

(57) ABSTRACT

A plastic container for a dry solid food, characterized in that it has a DLC (Diamond Like Carbon) film formed on the inner surface thereof, and has a steam permeability of 0 to 0.006 g/container/day and a steam permeability of 0 to 0.011 ml/container/day. The above gas permeability can be achieved by controlling the composition, density and film thickness of the DLC film. The plastic container can be suitably used for a dry and powdery food which has a smell, is susceptible to deterioration of quality by oxygen or is prone to agglomeration between fine particles by moisture and a dry and solid food which is markedly susceptible to deterioration of quality by moisture.

### TECHNICAL FIELD

The present invention is related to a plastic container for dry solid food which is useable as a container of dry solid food, in particular dry powdered food which has an aroma, in which quality deterioration occurs easily due to oxygen, and in which mutual cohesion between powder particles occurs easily when there are traces of moisture, or dry solid food in which acute quality deterioration occurs easily due to oxygen or moisture.

### PRIOR ART TECHNOLOGY

Generally, because containers made of plastic are easy to form, and have light weight and low cost, such containers are widely used as filled containers in various fields such as foods and medicines and the like.

However, as is well known, plastic is permeable to low molecular gases such as oxygen and carbon dioxide and the like, and has water molecule permeability properties. Namely, even in plastics that make it difficult for nonpolar gas molecules such as oxygen and carbon dioxide to permeate through, it is easy for polar molecules such as water molecules and the like to permeate through because the permeation mechanism inside the plastic is different from that of the nonpolar molecules described above. Similarly, even in plastics that make it difficult for polar molecules such as water molecules and the like to permeate through, it is easy for nonpolar gas molecules such as oxygen and carbon dioxide and the like to permeate through because of the different permeation mechanisms.

Further, because of the sorption and permeation of the molecules that form the aromatic components, plastic containers have various restrictions relating to the object of use and the type of use when compared to glass containers and the like.

Consequently, there is virtually no plastic which makes it difficult for both nonpolar molecules such as oxygen and carbon dioxide and polar molecules such as water and the like to permeate through, and which has little sorption of aromatic components. Olefin-type polypropylene containers and polyethylene containers have moistureproof properties, but did not have sufficient oxygen barrier properties and aroma preserving properties. On the other hand, PET containers have aroma preserving properties, but do not have sufficient oxygen barrier properties and moistureproof properties, and there has been a need for further improvement of performance.

Currently, polyvinylidene chloride containers are the only plastic containers understood by the inventors to have oxygen and carbon dioxide gas barrier properties, moistureproof properties, and aroma preserving properties.

However, polyvinylidene chloride containers have the disadvantage of having poor mechanical properties, and in the case where an incineration process is carried out for waste, a high temperature incineration is required due to the inclusion of chlorine.

### SUMMARY OF THE INVENTION

Incidentally, because dry food generally has little water, where the water content is less than or equal to 6% by weight, there is little microorganism contamination, but there has been the disadvantage of rapid moisture absorption. Accordingly, there is always a need to establish moistureproofing to maintain the quality of dry food.

Dry powdered food such as instant coffee and powdered milk and the like have aroma components, and easily undergo quality deterioration due to oxygen. Furthermore, because such food has a powder form, it is even more likely that there will be traces of moisture, and this makes it easy for mutual cohesion between powder particles to occur.

In this regard, glass containers or metal can containers which can be completely sealed have been used in order to block out moisture and oxygen without using any preserving agent, drying agent or the like, and prevent the characteristic aroma of coffee and the like from escaping, and the containers are frequently filled with nitrogen in order to prevent quality deterioration.

Further, with regard to seasoned laver and toasted laver which easily undergo acute quality deterioration due to oxygen and moisture, metal can containers or plastic film, wide-mouthed PET containers are used. Seasoned laver and toasted laver have a water content of 4˜6%, and both are placed in containers together with a moistureproofing agent such as quicklime or the like to maintain quality until reaching a consumer.

For example, in a wide-mouthed PET container, 48 sheets of 8-Kiri size toasted laver (total of 6 sheets, corresponding to 4 g/sheet×6=24 g) and 25 g of a moistureproofing agent (quicklime is the main component of packages for quicklime) were placed inside a container having the size external diameter φ76 mm×140 mmH (capacity: 430 ml, 25 g of PET resin). Toasted laver is dry, and has a distinctive texture, but acute quality deterioration (texture deterioration) occurs when toasted laver absorbs water.

Accordingly, in the packaging of toasted laver, at the same time packaging is carried out without absorbing water, it is necessary to create a redrying state by a moistureproofing agent even if water is absorbed.

However, it is wasteful to include a moistureproofing agent having roughly the same weight as the toasted laver, and after use, because this is a mixed manufactured product of plastic and a moistureproofing agent which are difficult to separate, processing as garbage becomes troublesome.

Among dry food, many spices (pepper, cinnamon, garlic, nutmeg, basil, curry powder, powdered wasabi, powdered Japanese pepper) are filled and packaged in glass containers or metal can containers. In particular, because the aroma components are very volatile, it was essential to use airtight containers and avoid contact with air.

Spicy components hate moisture, and because there are many volatile substances, it is essential to maintain a dry state and airtightness.

However, because plastic containers have properties such as ease of forming, light weight and low cost and the like as described above, it would be extremely convenient to be able to use plastic containers as containers of dry solid food, in particular dry powdered food which has an aroma, in which quality deterioration occurs easily due to oxygen, and in which mutual cohesion between powder particles occurs easily when there are traces of moisture, or dry solid food in which acute quality deterioration occurs easily due to oxygen or moisture.

Japanese Laid-Open Patent Publication No. HEI 8-53117 discloses a plastic container which has a DLC (Diamond Like Carbon) film formed on the inner wall surfaces thereof and a method of manufacturing such containers, wherein the container has superior gas barrier properties against oxygen and carbon dioxide, and is adapted for sparkling beverages and carbonated beverages which are sensitive to oxygen.

In this regard, a DLC film is a film called an i-carbon film or an amorphous carbon hydride film (a-C:H), and also includes a hard carbon film. Further, a DLC film is an amorphous-state carbon film, and includes SP³ bonding and SP² bonding. By forming this kind of DLC film on the inner wall surfaces of a plastic container, a container is obtained which can be used as a container for carbonated beverages and sparkling beverages.

The container of the disclosed invention described above is equipped with the properties of (1) good transparency so that the foreign material inspection is not hindered, and (2) little oxygen permeability.

Further, Japanese Laid-Open Patent Publication No. HEI 11-70152 discloses a film and the like for medical containers, wherein a diamond state carbon film having a hydrogen concentration of 50 atomic % or less and an oxygen concentration of 2˜20 atomic % is formed on at least one surface of a plastic film. Such film is a film that has transparency, oxygen barrier properties and water vapor barrier properties. This publication discloses embodiments related to polypropylene and polyethylene films which have superior water vapor barrier properties as material properties, but through which it is easy for oxygen to permeate. The oxygen permeability of 25 μm biaxial oriented polypropylene is 17.3 ml/m²/day. Further, the water vapor permeability is 4.5 g/m²/day which is an improvement of barrier properties by a factor of about 2 or 3 times.

However, even this carbon film coated plastic container does not satisfy the requirements that in addition to the basic properties that there should be (1) good transparency so that the foreign material inspection is not hindered, and (2) no chemical reaction with the contents, the container should also have (3) barrier properties for aromatic components, (4) little water vapor permeability, and (5) little oxygen permeability, and the like.

The object of the present invention is to provide a plastic container for dry solid food which is useable as a container of dry solid food, in particular dry powdered food which has an aroma, in which quality deterioration occurs easily due to oxygen, and in which mutual cohesion between powder particles occurs easily when there are traces of moisture, or dry solid food in which acute quality deterioration occurs easily due to oxygen or moisture.

The invention described in claim 1 is a plastic container for dry solid food having a DLC film formed on the inner surfaces thereof, wherein the water vapor permeability is 0˜0.006 g/container/day, and the oxygen permeability is 0˜0.011 ml/container/day. In this way, because it is possible to provide a plastic container for dry solid food having oxygen gas barrier properties and superior moistureproof properties, it is possible to prevent quality deterioration of dry solid food due to contamination by oxygen and moisture.

Further, the gas permeabilities of the nonpolar molecules nitrogen, oxygen and carbon dioxide for plastic are said to obey the general relationship 1:3.8:24.2 (Packaging Designs of Medicine, Masayasu Sugihara, Nanzando page 275). The carbon film coated plastic container of the present invention which has oxygen gas barrier properties also had carbon dioxide gas barrier properties in accordance with this general relationship.

The DLC film is formed from carbon atoms and hydrogen atoms, for example, polyethylene resin is also formed from the same atoms. However, in contrast with polyethylene which has both oxygen and water vapor permeabilities like other plastic resins, the carbon film coated container of the present invention has extremely low permeabilities for both of these gases. For these reasons, the present inventors presume the following.

A DLC film having a large hydrogen content of 50 atomic % will have a density lowered to 1.2˜1.3, and the carbon atoms and hydrogen atoms will form a polymer state. At this time, because the DLC film has expansion properties, cracks will not form by the expansion of the container, but because this is not a dense film, it is presumed that it will be easy for oxygen and water to permeate through.

Generally, in a plasma CVD (Chemical Vapor Deposition) method, when the high-frequency applied electric power is raised, the negative self-bias becomes large, and when the negative self-bias becomes large, a dense film is possible and the density of the film becomes higher due to the acceleration of the impact of positive ions. Further, there is a tendency for the negative self-bias to become larger as the pressure is lowered at the time of film formation.

When the high-frequency applied electric power is lowered, because a sufficient bias will not be provided, the synthesized DLC film will include a large number of hydrogen and graphite-like SP² bonds, a spongy film will be formed, and the density of the film will also be small. When the film thickness is too thin, the film will be patchy in a state where there are open holes, and the entire surface will not be covered. Further, when the film thickness becomes too thick, compressive stress occurs in the film itself, and this causes the film to crack and peel off.

Accordingly, the carbon film according to the present invention does not have gas barrier properties against oxygen and water vapor because it is a carbon film, and the present invention obtains these properties by appropriately changing the three conditions of composition, density and film thickness.

In this regard, the composition of the DLC film of the present invention is determined by the hydrogen atomic % and the carbon atomic %. Namely, theoretically due to the manufacturing conditions, it is possible for oxygen to be included as a structural atom other than hydrogen and carbon, but the amount thereof is extremely small. The oxygen atomic % is less than 0.2 atomic % (X-ray photoelectric spectral method, Model SSX-100 (manufactured by SSI Company)). Accordingly, in the DLC film of the present invention, if the hydrogen atomic % is 20 atomic %, the carbon atomic % is approximately 80 atomic %. Further, because the density of the DLC film of the present invention means the apparent density, if the film composition is determined, the density is not necessarily determined. Namely, even for the same composition, if the deposition rate is changed, because the denseness will change, this will have an effect on the gas barrier properties.

In the present invention, in particular by appropriately changing these three conditions, the carbon film coated container of the present invention is obtained. In the present invention, the composition, density and film thickness of the DLC film are indicated for carrying out appropriate changes.

As described later in the example embodiments, from the viewpoint of the oxygen barrier properties, the three conditions of the DLC film are as follows. Namely, the composition condition is that the hydrogen atomic % is 8˜45 atomic %, and preferably 10˜40 atomic %. The density condition is 1.3˜2.2 g/cm³, and preferably 1.4˜2.0 g/cm³. The film thickness condition is 150˜450 Å, and preferably 180˜420 Å.

From the viewpoint of the water vapor barrier properties, the three conditions of the DLC film are as follows. Namely, the composition condition is that the hydrogen atomic % is 10˜40 atomic %, and preferably 15˜35 atomic %. The density condition is 1.6˜2.1 g/cm³, and preferably 1.7˜2.0 g/cm³. The film thickness condition is 180˜350 Å, and preferably 200˜320 Å.

Accordingly, in order to obtain a plastic container for dry solid food equipped with both oxygen barrier properties and water vapor barrier properties, this is achieved by establishing the three conditions of the DLC film as follows. Namely, the composition condition is that the hydrogen atomic % is 10˜40 atomic %, and preferably 15˜35 atomic %. The density condition is 1.6˜2.1 g/cm³, and preferably 1.7˜2.0 g/cm³. The film thickness condition is 180˜350 Å, and preferably 200˜320 Å.

At this time, a plastic container for dry solid food can be obtained such that the water vapor permeability is 0˜0.006 g/container/day, and the oxygen permeability is 0˜0.011 ml/container/day in the plastic container having a DLC film formed on the inner surfaces thereof.

The invention described in claim 2 is the plastic container for dry solid food described in claim 1, wherein the dry solid food is a dry powdered food having an average particle diameter of 50 μm˜3 mm and a water content less than or equal to 6%, or a dry solid food having a water content less than or equal to 6%. In this way, in particular for dry powdered food, it is possible to prevent mutual cohesion between powder particles due to traces of moisture. Further, by maintaining the dry state of dry solid food, there is no loss of texture over a long period of time.

The invention described in claim 3 is the plastic container for dry solid food described in claim 2, wherein the dry powdered food is instant coffee, spice or powdered milk. Dry powdered food such as instant coffee, powdered milk, spice and the like have aroma components, and easily undergo quality deterioration due to oxygen. Furthermore, because such food has a powder form, it is even more likely that there will be traces of moisture, and this makes it easy for mutual cohesion between powder particles to occur. Accordingly, with regard to dry solid food having a strong aroma such as spice and the like, the present invention makes it possible to prevent cohesion of powder particles while maintaining dryness for a long period of time without the aroma escaping.

The invention described in claim 4 is the plastic container for dry solid food described in claim 2, wherein the dry solid food is dried laver. In this way, with regard to dry solid food such as toasted laver and the like which particularly require moistureproofing, a dry state can be maintained over a long period of time, and because this makes it possible for there to be no need for a moistureproofing agent, it becomes unnecessary to separately provide a plastic container and a moistureproofing agent, whereby there is the result that the processing of the container after use also becomes easy.

The invention described in claim 5 is the plastic container for dry solid food described in any one of claims 1˜4, wherein the plastic container is formed by polyethylene terephthalate resin.

As for the plastic, polyethylene terephthalate resin, polyethylene resin, polypropylene resin, polystyrene resin, cycloolefin copolymer resin, polyethylene naphthalate resin, ethylene-vinyl alcohol copolymer resin, poly-4-methylpentene-1 resin, polymethyl methacrylate resin, acrylonitrile resin, polyvinyl chloride resin, polyvinylidene chloride resin, acrylonitrile-styrene resin, acrylonitrile-butadiene-styrene resin, polyamide resin, polyamide-imide resin, polyacetal resin, polycarbonate resin, polybutylene terephthalate resin, ionomer resin, polysulfone resin, or ethylene tetrafluoride resin may be used, but polyethylene terephthalate is more preferred, and when a DLC film is formed on a container made of polyethylene terephthalate, the container will exhibit superior properties.

In accordance with the present invention, by making particularly appropriate changes of the three conditions of the composition, density and film thickness of the DLC film, because it is possible to provide a plastic container for dry solid food having oxygen gas barrier properties and superior moistureproof properties, it is possible to prevent quality deterioration of dry solid food due to contamination by oxygen and moisture.

For example, with regard to dry powdered food, it is possible to prevent mutual cohesion between powder particles due to traces of moisture. Accordingly, the plastic container of the present invention is suitable as a container of dry powdered food such as instant coffee and powdered milk and the like.

For example, in the packaging of dry solid food, in particular dried laver such as toasted laver or seasoned laver, by maintaining the dry state of the dry solid food, there is no loss of texture over a long period of time. Furthermore, preferably because this makes it possible for there to be no need for a moistureproofing agent, it becomes unnecessary to separately provide plastic and a moistureproofing agent, whereby there is the result that the processing of the container after use also becomes easy.

For example, with regard to dry solid food such as spice and the like which have a strong aroma, because storage can be carried out while maintaining dryness for a long period of time without the aroma escaping, the plastic container of the present invention can be said to be suitable as a container which is filled and packaged with these.

As for the material of the plastic container, superior performance is exhibited by the case where the plastic container is manufactured from polyethylene terephthalate.

### BRIEF DESCRIPTION OF THE DRAWINGS

FIG. 1 is a drawing showing one embodiment of a manufacturing apparatus for manufacturing the plastic container for dry solid food according to the present invention. The applied symbols in FIG. 1 have the following meanings: 1 is a base, 1 A is an exhaust outlet, 2 is a shoulder portion electrode, 3 is a body portion electrode, 4 is a bottom portion electrode, 5 is a plastic container, 6 is an insulator, 7 is an O-ring, 8 is an interface device, 9 is a high-frequency oscillator, 10 is a housing portion, 11 is an inner electrode, and 12 is a pipeline.

### PREFERRED EMBODIMENTS OF THE INVENTION

First, a description will be given for the manufactured embodiments of a carbon film coated plastic container of the present invention.

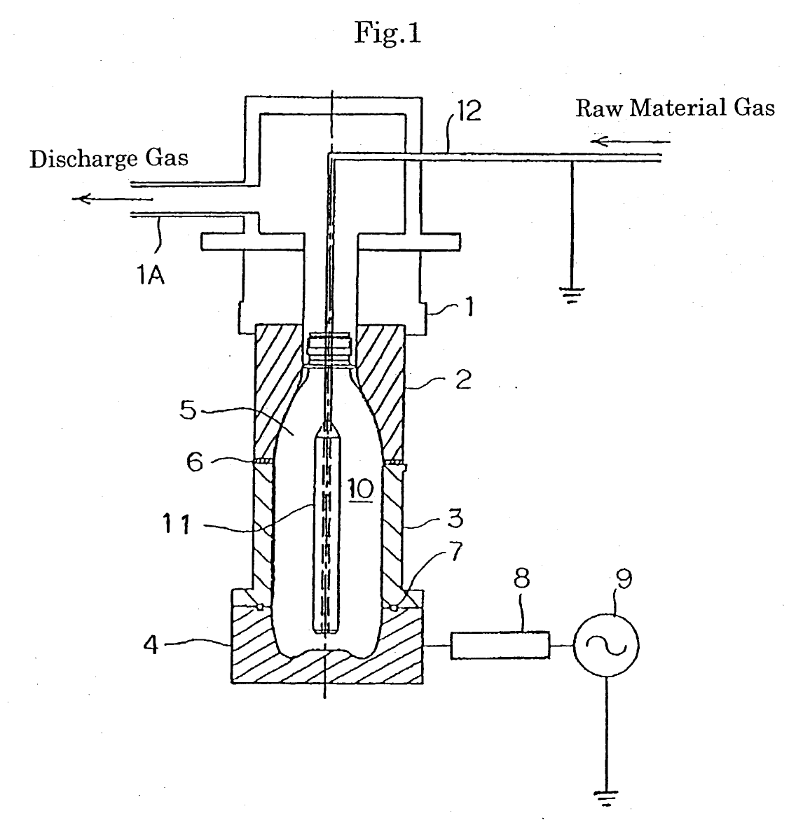

FIG. 1 is a drawing showing the electrode structure and the like of the present apparatus. As shown in FIG. 1, the present apparatus is equipped with a base 1, a shoulder portion electrode 2 and a body portion electrode 3 mounted to the base 1, and a bottom portion electrode 4 which can be connected to and disconnected from the body portion electrode 3. As shown in FIG. 1, the shoulder portion electrode 2, the body portion electrode 3 and the bottom portion electrode 4 each have inner wall surfaces shaped like the outer shape of a plastic container 5, in which the shoulder portion electrode 2 is arranged along the shoulder portion of the plastic container 5, the body portion electrode 3 is arranged along the body portion of the plastic container 5, and the bottom portion electrode 4 is arranged along the bottom portion of the plastic container 5. The shoulder portion electrode 2, the body portion electrode 3 and the bottom portion electrode 4 form the outer electrodes of the present apparatus.

When the bottom portion electrode 4 is mounted to the body portion electrode 3, the base 1, the shoulder portion electrode 2, the body portion electrode 3 and the bottom portion electrode 4 form a mutually airtight mounted state, and these function as a vacuum chamber equipped with a housing portion 10 for housing the plastic container 5.

As shown in FIG. 1, an insulator 6 is provided between the shoulder portion electrode 2 and the body portion electrode 3, and in this way the shoulder portion electrode 2 and the body portion electrode 3 are electrically insulated from each other. Further, an O-ring 7 is provided between the body portion electrode 3 and the bottom portion electrode 4, and when the bottom portion electrode 4 is mounted, a small gap is formed between the bottom portion electrode 4 and the body portion electrode 3.

In this way, while ensuring airtightness between the bottom portion electrode 4 and the body portion electrode 3, electrical insulation is carried out between both electrodes.

An inner electrode 11 is provided in the housing portion 10, and the inner electrode 11 is inserted into the inside of the plastic container 5 housed inside the housing portion 10. The inner electrode 11 is electrically connected to a ground potential.

The inner electrode 11 is formed to have a hollow shape (tube shape), and one blowout hole (not shown in the drawing) which communicates the inside and the outside of the inner electrode 11 is formed in the lower end thereof. Further, instead of providing a blowout hole in the lower end, a plurality of blowout holes (not shown in the drawing) may be formed to pass through the inside and the outside of the inner electrode 11 in the radial direction. A pipeline 12 which communicates with the inside of the inner electrode 11 is connected to the inner electrode 11, and this structure makes it possible for a source gas fed into the inside of the inner electrode 11 via the pipeline 12 to be emitted into the inside of the plastic container 5 via the blowout hole. Further, the pipeline 12 is made of metal and has electrical conductivity, and as shown in FIG. 1, the pipeline 12 is used to connect the inner electrode 11 to a ground potential. Further, the inner electrode 11 is supported by the pipeline 12.

As shown in FIG. 1, the output terminal of a high-frequency oscillator 9 is connected to the bottom portion electrode 4 via an interface device 8. The high-frequency oscillator 9 generates a high-frequency voltage between itself and the ground potential, and in this way a high-frequency voltage is applied between the inner electrode 11 and the bottom portion electrode 4.

Next, a description will be given for the process when a DLC (Diamond Like Carbon) film is formed on the inner wall surfaces of the plastic container 5 using the present apparatus.

The plastic container 5 is set so that the bottom portion thereof makes contact with the inner surface of the bottom portion electrode 4, and by raising the bottom portion electrode 4, the plastic container 5 is housed in the housing portion 10. At this time, the inner electrode 11 provided in the housing portion 10 is inserted inside the plastic container 5 through the orifice (upper end opening) of the plastic container 5.

When the bottom portion electrode 4 is raised to a prescribed position to hermetically seal the housing portion 10, a state is formed in which the outer periphery of the plastic container 5 makes contact with the inner surfaces of the shoulder portion electrode 2, the body portion electrode 3 and the bottom portion electrode 4. Next, the air inside the housing portion 10 is exhausted through an exhaust outlet 1A of the base 1 by a vacuum device not shown in the drawing. After the pressure inside the housing portion 10 has been reduced to a required vacuum level, a source gas (e.g., carbon source gases such as aliphatic hydrocarbons, aromatic hydrocarbons and the like) supplied via the pipeline 12 is introduced into the inside of the plastic container 5 from the blowout hole of the inner electrode 11.

After the concentration of the source gas reaches a prescribed value, the high-frequency oscillator 9 (e.g., 13.56 MHz) is activated to apply a high-frequency voltage between the inner electrode 11 and the outer electrodes, whereby a plasma is generated inside the plastic container 5. In this way, a DLC film is formed on the inner wall surfaces of the plastic container 5.

Namely, the formation of a DLC film on the inner wall surfaces of the plastic container 5 is carried out by a plasma CVD method, wherein electrons accumulate on the inner wall surfaces of the outer electrodes insulated by the plasma generated between the outer electrodes and the inner electrode 11, and a prescribed fall in potential occurs.

In this way, the carbon and the hydrogen of the hydrocarbon that forms the source gas present in the plasma are each ionized to positive. Then, due to the attractive electrostatic force between the ions and the electrons accumulated on the inner wall surfaces, the ions will be attracted by and randomly collide with the inner wall surface of the plastic container 5 running along the inner wall surfaces of the outer electrodes, whereby an extremely dense hard carbon film made from DLC is formed on the inner wall surface of the plastic container 5 by the bonding between adjacent carbon atoms and the bonding between carbon atoms and hydrogen atoms, and by the breaking of bonds of hydrogen atoms that have bonded once (sputtering effect).

As described above, the output terminal of the high-frequency oscillator 9 is connected to only the bottom portion electrode 4. Further, a gap is formed between the bottom portion electrode 4 and the body portion electrode 3, and the bottom portion electrode 4 and the body portion electrode 3 are electrically insulated from each other. Furthermore, the insulator 6 is provided between the body portion electrode 3 and the shoulder portion electrode 2, and the body portion electrode 3 and the shoulder portion electrode 2 are electrically insulated from each other. Accordingly, the high-frequency electric power applied to the body portion electrode 3 and the shoulder portion electrode 2 becomes smaller than the high-frequency electric power applied to the bottom portion electrode 4. However, because capacity coupling is carried out through the respective gaps between the bottom portion electrode 4 and the body portion electrode 3, and between the body portion electrode 3 and the shoulder portion electrode 2, a certain degree of high-frequency electric power is also applied to the body portion electrode 3 and the shoulder portion electrode 2.

In general, the bottom portion of plastic containers such as bottles and the like have complex shapes, and it is difficult to form a DLC film having a uniform film thickness, composition and density. For this reason, even after the DLC film is formed, the gas barrier properties of the bottom portion of the container are prone to lowering.

In contrast with this, by means of the manufacturing apparatus of the embodiment described above, because it is possible to apply high-frequency electric power larger than that for the body portion and shoulder portion to the bottom portion of the plastic container, it is possible to uniformly form a DLC film having a prescribed film thickness, composition and density on the entire bottle, and it is possible to effectively improve the gas barrier properties for the entire container. In the embodiment described above, the applied electric power was 800˜1400W.

In the embodiment described above, the shoulder portion electrode 2, the body portion electrode 3 and the bottom portion electrode 4 are constructed so as to be completely insulated against direct current, but it is also possible to connect each of the electrodes to each other by resistance or capacitive elements or the like. In short, so long as it is possible to apply high-frequency electric power having a required strength in accordance with each portion of the container, for example, a plurality of high-frequency oscillators may be provided to apply high-frequency electric power separately to each of the electrodes of the shoulder portion electrode 2, the body portion electrode 3 and the bottom portion electrode 4, or the output of a single high-frequency oscillator may be connected to each of the electrodes via a plurality of interface devices.

In the embodiment described above, an example was described for the case where the outer electrodes are divided into three portions, but the outer electrodes may be divided into two portions, or the outer electrodes may be divided into four or more portions.

Further, in the embodiment described above, a description was given for a container having a shape that makes it difficult to form a DLC film on the bottom portion, but by adjusting the distribution of the applied high-frequency electric power in accordance with the shape of the container, it is possible to form a good DLC film over the entire container.

Accordingly, in the case of container shapes that make it easy to form a DLC film on the bottom portion, it is possible to form a good DLC film over the entire container by adjusting the distribution of applied high-frequency electric power without dividing the outer electrodes.

In the embodiment described above, a description was given for manufacturing based on a high-frequency plasma CVD method. In the embodiment described above, it is possible to form a DLC film having a prescribed composition, density and film thickness as far as the bottom portion even for bottles having complex shapes. By adjusting such formation conditions to the three conditions mentioned in the example embodiments described below, it is possible to achieve the invention of a carbon film coated plastic container having prescribed properties, namely, in addition to the basic properties of (1) good transparency so that the foreign material inspection is not hindered, and (2) no chemical reaction with the contents, the container should also have (3) barrier properties for aromatic components, (4) little water vapor permeability, and (5) little oxygen permeability, and the like.

However, the method of forming the DLC film is not limited to the method of the embodiment described above. For example, a DLC film may be formed by a manufacturing apparatus based on a microwave plasma CVD method or the like.

### EXAMPLE EMBODIMENTS

In the example embodiments, 500 ml PET containers (weight 30 g, thickness 0.3 mm) were prepared in accordance with the principle of the present invention, and the inner surface area of these containers was 400 cm²/container. Accordingly, the gas barrier properties are calculated per one container. In the case where these are converted per unit surface area (m²), conversion may be carried out by considering the inner surface area of the container used for evaluation. Further, because there is almost no gas permeation from the cover, the surface area thereof does not enter into consideration. However, the present invention is not limited by the volume or shape of the containers of the example embodiments. Further, the PET containers were formed using polyethylene terephthalate resin (Nihon Yunipet (Inc.) RT543 (Intrinsic Viscosity 0.77)).

Method of Analysis

(1) Measurement of Film Thickness

Thickness was measured by Tenchol Company's alpha-step500 tracer type difference meter.

(2) Surface Area

Measurement was carried out by CAD from the bottle drawing. There was approximately 400 cm² per one container.

(3) Measurement of Film Weight

The PET bottles were shredded, flakes were placed in a beaker, a reaction with an aqueous solution of 4% NaOH at normal temperature was carried out for 10 hours, and the DLC film was peeled off. This solution was filtered by a milli-pore filter (pore diameter 0.5 μm) made of polytetrafluoroethylene, drying was carried out at 105° C., and the weight of the DLC film was calculated from the weights before and after filtering. Because the alkaline solution remains as an impurity, the blank value of the alkaline solution was also calculated, and the weight of the DLC film was corrected.

(4) Measurement of Film Density

The density was calculated from Equation 1.

Density=Weight÷(Surface Area×Thickness) Equation 1

(5) Measurement of Hydrogen Atomic Content of Film

The hydrogen atomic % (percentage of the number of hydrogen atoms) of the DLC film was measured¹⁾ using a Shimadzu IBA-9900EREA (elastic recoil detection analysis, elastic recoil particle detection method). 1) A. Kimura, Y. Nakatani, K. Yamada, T. Suzuki, Diamond Relat. Mater. 8 (1999) 37.

(6) Oxygen Permeability

Measurements were made using an Oxtran manufactured by Modern Control Company under the conditions 22° C.×60% RH.

(7) Water Permeability

Measurements were made using an Oxtran manufactured by Modern Control Company under the conditions 40° C. ×90% RH.

### EXAMPLE EMBODIMENTS FOR COMPARING OXYGEN PERMEABILITY AND WATER VAPOR PERMEABILITY OF CARBON FILM COATED CONTAINERS

### Example Embodiment 1

Using the apparatus described above, a DLC film was formed on the inner surfaces of a 500 ml PET container with acetylene gas as the source material. Table 1 shows the conditions for forming the DLC film in the present invention. Table 2 shows the various physical properties of the containers depending on the film thickness, density and composition (indicated by the hydrogen content) corresponding to the example embodiments of Table 1. The coating conditions were established as mentioned in Example Embodiment 1 of Table 1. The film thickness, density and composition of Example Embodiment 1 and the physical property values of the film thereof are shown in Table 2.

### Example Embodiments 2˜19

In the same manner, the film thickness, density and composition of the formed DLC film was changed to establish the example embodiments 2˜19 of Table 1. The measured values of the oxygen permeabilities and the water vapor permeabilities at such time are shown in the same manner in Table 2.

### Reference Examples 1˜13

DLC films were formed by shifting the conditions for the reference examples from the three conditions of film thickness, density and composition of the DLC films of the example embodiments. The coating conditions were established like the reference examples 1˜13 of Table 1. The various physical properties of the containers at such time are shown in the same manner in Table 2.

Blank Space Below

TABLE 1

| | | | Film | | | | |
|---|---|---|---|---|---|---|---|
| | | High-Frequency | Forming | Gas Flow | | | Hydrogen |
| Example | Discharge | Electric Power | Pressure | Rate | Thickness | Density | Atomic |
| Embodiments | Method | w | torr | sccm | Å | g/cm³ | % |
| Example Embodiment 1 | Bottom | 800 | 0.05 | 31 | 180 | 1.6 | 40 |
| Example Embodiment 2 | Bottom | 800 | 0.05 | 31 | 350 | 1.6 | 40 |
| Example Embodiment 3 | Bottom | 1200 | 0.05 | 31 | 180 | 2.1 | 10 |
| Example Embodiment 4 | Bottom | 1200 | 0.05 | 31 | 350 | 2.1 | 10 |
| Example Embodiment 5 | Bottom | 900 | 0.05 | 31 | 200 | 1.7 | 30 |
| Example Embodiment 6 | Bottom | 900 | 0.05 | 31 | 320 | 1.7 | 30 |
| Example Embodiment 7 | Bottom | 1200 | 0.05 | 31 | 200 | 2.0 | 15 |
| Example Embodiment 8 | Bottom | 1200 | 0.05 | 31 | 320 | 2.0 | 15 |
| Example Embodiment 9 | Bottom | 900 | 0.05 | 31 | 220 | 1.6 | 35 |
| Example Embodiment 10 | Bottom | 900 | 0.05 | 31 | 350 | 1.6 | 35 |
| Example Embodiment 11 | Bottom | 1200 | 0.03 | 31 | 220 | 2.1 | 10 |
| Example Embodiment 12 | Bottom | 1200 | 0.03 | 31 | 350 | 2.1 | 10 |
| Example Embodiment 13 | Bottom | 900 | 0.05 | 31 | 250 | 1.7 | 30 |
| Example Embodiment 14 | Bottom | 1200 | 0.05 | 31 | 250 | 2.0 | 10 |
| Example Embodiment 15 | Bottom | 900 | 0.05 | 31 | 320 | 1.7 | 30 |
| Example Embodiment 16 | Bottom | 1200 | 0.05 | 31 | 320 | 2.0 | 10 |
| Example Embodiment 17 | Bottom | 1000 | 0.07 | 31 | 270 | 1.8 | 26 |
| Example Embodiment 18 | Bottom | 900 | 0.05 | 31 | 300 | 1.6 | 35 |
| Example Embodiment 19 | Bottom | 1000 | 0.07 | 31 | 300 | 1.8 | 26 |
| Reference Example 1 | Bottom | 800 | 0.07 | 31 | 150 | 1.3 | 45 |
| Reference Example 2 | Bottom | 1300 | 0.03 | 31 | 450 | 2.2 | 8 |
| Reference Example 3 | Bottom | 1300 | 0.03 | 31 | 400 | 2.2 | 8 |
| Reference Example 4 | Bottom | 1100 | 0.05 | 31 | 100 | 1.9 | 20 |
| Reference Example 5 | Bottom | 1100 | 0.05 | 31 | 500 | 1.9 | 20 |
| Reference Example 6 | Bottom | 800 | 0.07 | 31 | 300 | 1.2 | 48 |
| Reference Example 7 | Bottom | 1400 | 0.03 | 31 | 250 | 2.3 | 6 |
| Reference Example 8 | Bottom | 1300 | 0.03 | 31 | 50 | 2.2 | 8 |
| Reference Example 9 | Bottom | 1300 | 0.03 | 31 | 100 | 2.2 | 8 |
| Reference Example 10 | Bottom | 1300 | 0.03 | 31 | 300 | 2.2 | 8 |
| Reference Example 11 | Bottom | 800 | 0.07 | 31 | 450 | 1.3 | 45 |
| Reference Example 12 | Bottom | — | — | 31 | 0 | — | — |
| (Only PET) | | | | | | | |
| Reference Example 13 | Bottom | — | — | 31 | 0 | — | — |
| (Only PP) | | | | | | | |

TABLE 2

| | | | Composi- | | | | | | |
|---|---|---|---|---|---|---|---|---|---|
| | | | tion | Permeability and Evaluation | | | | | |
| | | | Hydrogen | Oxygen | | Water Vapor | | Ethanol | |
| Example | Thickness | Density | Atomic | ml/container/ | Evalu- | g/container/ | Evalu- | g/container/ | Evalu- |
| Embodiments | Å | g/cm³ | % | day | ation | day | ation | month | ation |
| Example Embodiment 1 | 180 | 1.6 | 40 | 0.004 | ◯ | 0.006 | ◯ | 0.12 | X |
| Example Embodiment 2 | 350 | 1.6 | 40 | 0.004 | ◯ | 0.006 | ◯ | 0.10 | X |
| Example Embodiment 3 | 180 | 2.1 | 10 | 0.007 | ◯ | 0.005 | ◯ | 0.11 | X |
| Example Embodiment 4 | 350 | 2.1 | 10 | 0.006 | ◯ | 0.006 | ◯ | 0.05 | ◯ |
| Example Embodiment 5 | 200 | 1.7 | 30 | 0.004 | ⊚ | 0.003 | ⊚ | 0.10 | X |
| Example Embodiment 6 | 320 | 1.7 | 30 | 0.004 | ⊚ | 0.003 | ⊚ | 0.02 | ⊚ |
| Example Embodiment 7 | 200 | 2.0 | 15 | 0.003 | ⊚ | 0.003 | ⊚ | 0.09 | X |
| Example Embodiment 8 | 320 | 2.0 | 15 | 0.003 | ⊚ | 0.003 | ⊚ | 0.03 | ⊚ |
| Example Embodiment 9 | 220 | 1.6 | 35 | 0.004 | ⊚ | 0.006 | ◯ | 0.04 | ◯ |
| Example Embodiment 10 | 350 | 1.6 | 35 | 0.004 | ⊚ | 0.006 | ◯ | 0.05 | ◯ |
| Example Embodiment 11 | 220 | 2.1 | 10 | 0.005 | ◯ | 0.005 | ◯ | 0.04 | ◯ |
| Example Embodiment 12 | 350 | 2.1 | 12 | 0.006 | ◯ | 0.006 | ◯ | 0.03 | ⊚ |
| Example Embodiment 13 | 250 | 1.7 | 30 | 0.004 | ⊚ | 0.003 | ⊚ | 0.02 | ⊚ |
| Example Embodiment 14 | 250 | 2.0 | 10 | 0.003 | ⊚ | 0.004 | ◯ | 0.04 | ◯ |
| Example Embodiment 15 | 320 | 1.7 | 30 | 0.003 | ⊚ | 0.002 | ⊚ | 0.02 | ⊚ |
| Example Embodiment 16 | 320 | 2.0 | 10 | 0.003 | ⊚ | 0.004 | ◯ | 0.05 | ◯ |
| Example Embodiment 17 | 270 | 1.8 | 26 | 0.002 | ⊚ | 0.002 | ⊚ | 0.01 | ⊚ |
| Example Embodiment 18 | 300 | 1.6 | 35 | 0.003 | ⊚ | 0.006 | ◯ | 0.04 | ◯ |
| Example Embodiment 19 | 300 | 1.8 | 26 | 0.002 | ⊚ | 0.003 | ⊚ | 0.02 | ⊚ |
| Reference Example 1 | 150 | 1.3 | 45 | 0.008 | ◯ | 0.012 | X | 0.09 | X |
| Reference Example 2 | 450 | 2.2 | 8 | 0.011 | ◯ | 0.011 | X | 0.10 | X |
| Reference Example 3 | 400 | 2.2 | 8 | 0.008 | ◯ | 0.013 | X | 0.11 | X |
| Reference Example 4 | 100 | 1.9 | 20 | 0.019 | X | 0.014 | X | 0.11 | X |
| Reference Example 5 | 500 | 1.9 | 20 | 0.024 | X | 0.015 | X | 0.12 | X |
| Reference Example 6 | 300 | 1.2 | 48 | 0.028 | X | 0.015 | X | 0.13 | X |
| Reference Example 7 | 250 | 2.3 | 6 | 0.025 | X | 0.018 | X | 0.12 | X |
| Reference Example 8 | 50 | 2.2 | 8 | 0.029 | X | 0.017 | X | 0.16 | X |
| Reference Example 9 | 100 | 2.2 | 8 | 0.023 | X | 0.015 | X | 0.14 | X |
| Reference Example 10 | 300 | 2.2 | 8 | 0.010 | ◯ | 0.012 | X | 0.16 | X |
| Reference Example 11 | 300 | 1.3 | 45 | 0.011 | ◯ | 0.011 | X | 0.11 | X |
| Reference Example 12 | 0 | — | — | 0.033 | X | 0.020 | X | 0.19 | X |
| (Only PET) | | | | | | | | | |
| Reference Example 13 | 0 | — | — | 1.05 | X | 0.006 | ◯ | 0.68 | X |
| (Only PP) | | | | | | | | | |

With regard to the plastic container for dry food of the present invention, from the viewpoint of the oxygen barrier properties, the three conditions of the DLC film are as follows. Namely, the composition condition is that the hydrogen atomic % is 8˜45 atomic %, and preferably 10˜40 atomic %. The density condition is 1.3˜2.2 g/cm³, and preferably 1.4˜2.0 g/cm³. When the film thickness is too thin, the film will be patchy in a state where there are open holes, and the entire surface will not be covered. Further, when the film thickness becomes too thick, compressive stress occurs in the film itself, and this causes the film to crack and peel off. Accordingly, the film thickness condition is 150˜450 Å, and preferably 180˜420 Å.

From the viewpoint of the water vapor barrier properties, the three conditions of the DLC film are as follows. Namely, the composition condition is that the hydrogen atomic % is 10˜40 atomic %, and preferably 15˜35 atomic %. The density condition is 1.6˜2.1 g/cm³, and preferably 1.7˜2.0 g/cm³. The film thickness condition is 180˜350 Å, and preferably 200˜320 Å.

Accordingly, in order to obtain a plastic container for dry solid food equipped with both oxygen barrier properties and water vapor barrier properties, this is achieved by establishing the three conditions of the DLC film as follows. Namely, the composition condition is that the hydrogen atomic % is 10˜40 atomic %, and preferably 15˜35 atomic %. The density condition is 1.6˜2.1 g/cm³, and preferably. 1.7˜2.0 g/cm³. The film thickness condition is 180˜350 Å, and preferably 200˜320 Å.

At this time, it is possible to obtain a plastic container for dry solid food having a DLC film formed on the inner surfaces thereof, wherein the water vapor permeability is 0˜0.006 g/container/day, and the oxygen permeability is 0˜0.011 ml/container/day.

### EXAMPLE EMBODIMENTS FOR COMPARING OXYGEN PERMEABILITY AND WATER VAPOR PERMEABILITY OF DLC FILMS FORMED ON PLASTIC FILMS

According to Japanese Laid-Open Patent Publication No. HEI 11-70152, a diamond state carbon film having a hydrogen concentration of 50 atomic % or less and an oxygen concentration of 2˜20 atomic % is introduced. The oxygen permeability of 25 μm biaxial oriented polypropylene is 17.3 ml/m²/day, and the water vapor permeability is 4.5 g/m²/day which is an improvement of barrier properties by a factor of about 2 or 3 times. The inner surfaces of PET containers were covered by a 12 μm thick PET film, and the film obtained by forming a DLC film under the conditions of Example Embodiment 15 of Table 1 formed Example Embodiment 20, and the film obtained by forming a DLC film under the conditions of 17 of Table 1 formed Example Embodiment 21, and the various physical properties of these films are shown in Table 3. As for the 12 μm PET films of the present invention, as shown in Example Embodiments 20, 21 of Table 3, in contrast with the films not formed with a DLC film, the oxygen gas barrier properties were about 100 times better, and the water vapor permeability was about 30 times better.

TABLE 3

| | | | Composition | | |
|---|---|---|---|---|---|
| | | | Hydrogen | | |
| | | | Atom | Permeability | |
| | Film | | Content | Oxygen | |
| Example | Thickness | Density | Hydrogen | ml/m²/ | Water |
| Embodiment | Å | g/cm³ | Atomic % | Day | g/m²/Day |
| Reference | 0 | — | — | 85 | 45 |
| Example 14 | | | | | |
| (PET12 μm) | | | | | |
| Reference | 0 | — | — | 100 | 50 |
| Example 15 | | | | | |
| (PET12 μm) | | | | | |
| Example | 200 | 1.6 | 35 | 1.0 | 2.0 |
| Embodiment | | | | | |
| 20 | | | | | |
| Example | 250 | 2.0 | 19 | 0.8 | 1.5 |
| Embodiment | | | | | |
| 21 | | | | | |

### EXAMPLE EMBODIMENTS FOR COMPARING THE PRESERVABILITY OF DRY FOOD (INSTANT COFFEE) OF CARBON FILM COATED CONTAINERS

The containers were wide-mouthed and had a size of 360 ml (inner surface area of approximately 320 cm²). The container formed with a DLC film under the same conditions as the conditions of Example Embodiment 4 of Table 1 formed Example Embodiment 22 of Table 4, and in the same manner the container formed with a DLC film under the same conditions as the conditions of Example Embodiment 17 of Table 1 formed Example Embodiment 23 of Table 4. Further, in the same manner for the reference examples, the container formed with a DLC film under the same conditions as the conditions of Reference Example 12 of Table 1 formed Reference Example 16 of Table 4, and the container formed with a DLC film under the same conditions as the conditions of Reference Example 9 of Table 1 formed Reference Example 17 of Table 4. The evaluation method is as follows.

(1) Instant coffee which is available on the market in glass bottles was obtained. A product was selected as close as possible to the time directly after manufacturing and selling. The instant coffee was transferred to various containers including a glass bottle, and the open portions were sealed by a laminated film of polyethylene and aluminum foil.

(2) The containers were kept in an air-conditioned chamber at 40° C.×75% RH, and then evaluations were carried out after 1, 3 and 6 months.

(3) The granules were stirred at 105° C., and the extracted water content was measured.

(4) With regard to aroma, evaluations were carried out by a panel of five people after the seals were broken according to the following four rankings: \mathring{◯} good, ◯ average, Δ slightly poor, × poor.

(5) Appearance was observed by laterally rolling and inverting the containers in a sealed state.

(6) The containers used as reference examples were as follows. There was a glass container (360 ml capacity), and wide-mouthed PET containers (capacity: 360 ml, the inner surface area excluding the cover portion was approximately 320 cm², 25 g of PET resin, and an average thickness of 0.25 mm). Table 4 shows the evaluation of the preservability of coffee by the plastic containers for dry solid food according to the present invention.

Blank Space Below

TABLE 4

| | Storage | Water | | | |
|---|---|---|---|---|---|
| | Period | content | | | Overall |
| | (Months) | (%) | Aroma | Appearance | Evaluation |
| Glass | 0 | 3.4 | ⊚ | ⊚ | |
| | 1 | 3.6 | ⊚ | ⊚ | |
| | 3 | 3.5 | ⊚ | ⊚ | |
| | 6 | 3.6 | ⊚ | ⊚ | ⊚ |
| Reference | 1 | 4.0 | ◯ | ◯ | |
| Example 16 | 3 | 5.5 | ◯ | Δ | |
| (Only PET) | 6 | 6.8 | Δ | X Turned | X˜Δ |
| | | | | black and | |
| | | | | stuck | |
| | | | | together | |
| Reference | 1 | 3.9 | ◯ | ⊚ | |
| Example 17 | 3 | 4.7 | Δ | ◯ | |
| | 6 | 6.0 | Δ | Δ | Δ |
| Example | 1 | 3.6 | ⊚ | ⊚ | |
| Embodiment | 3 | 4.0 | ⊚ | ⊚ | |
| 22 | 6 | 4.5 | ◯ | ◯ | ◯˜⊚ |
| Example | 1 | 3.5 | ⊚ | ⊚ | |
| Embodiment | 3 | 3.6 | ⊚ | ⊚ | |
| 23 | 6 | 3.8 | ⊚ | ⊚ | ⊚ |

Coffee 100 g
Temperature: 40° C., Humidity: RH75%
⊚ Good, ◯ Average, Δ Slightly Poor, X Poor
(Note)
The water content of instant coffee is generally 2˜5%.

Example embodiments 22 and 23 were confirmed to have the same preservability as the glass container. Accordingly, because mutual cohesion between particles is suppressed for dry powdered food such as instant coffee and the like, the plastic container for dry solid food of the present invention can be said to be suitable as a container which is filled and packaged with these.

### EXAMPLE EMBODIMENTS FOR COMPARING THE PRESERVABILITY OF DRY FOOD (SPICE) OF CARBON FILM COATED CONTAINERS

The containers had a size of 30 ml (inner surface area excluding the cover portion was approximately 50 cm²). The container formed with a DLC film under the same conditions as the conditions of Example Embodiment 4 of Table 1 formed Example Embodiment 24 of Table 5, and in the same manner the container formed with a DLC film under the same conditions as the conditions of Example Embodiment 17 of Table 1 formed Example Embodiment 25 of Table 5. Further, in the same manner for the reference examples, the container formed with a DLC film under the same conditions as the conditions of Reference Example 12 of Table 1 formed Reference Example 18 of Table 5, and the container formed with a DLC film under the same conditions as the conditions of Reference Example 9 of Table 1 formed Reference Example 19 of Table 5. The evaluation method is as follows.

(1) Nutmeg which is available on the market in glass bottles was obtained. A product was selected as close as possible to the time directly after manufacturing and selling. The pepper was transferred to various containers including a glass bottle, and the open portions were sealed by a laminated film of polyethylene and aluminum foil. p0 (2) The containers were kept in an air-conditioned chamber at 40° C.×75% RH, and then evaluations were carried out after 1, 3 and 6 months.

(3) The powder was stirred at 105° C., and the extracted water content was measured.

(4) With regard to aroma, evaluations were carried out by a panel of five people after the seals were broken according to the following four rankings: ⊚ good, ◯ average, Δ slightly poor, poor.

(5) The containers used as reference examples were as follows. There was a glass container (30 ml capacity), and wide-mouthed PET containers (capacity: 30 ml, surface area excluding the cover portion: approximately 50 cm², 6 g of PET resin, and an average thickness of 0.25 mm).

Table 5 shows the evaluation of the preservability of spice (nutmeg) for the plastic containers for dry solid food according to the present invention.

Blank Space Below

TABLE 5

| | Storage | Water | | |
|---|---|---|---|---|
| | Period | content | | Overall |
| | (Months) | (%) | Aroma | Evaluation |
| Glass | 0 | 6.3 | ⊚ | |
| | 1 | 6.2 | ⊚ | |
| | 3 | 6.4 | ⊚ | |
| | 6 | 6.2 | ⊚ | ⊚ |
| Reference | 1 | 6.6 | ◯ | |
| Example 18 | 3 | 7.6 | Δ | |
| (Only PET) | 6 | 8.3 | X | X˜Δ |
| Reference | 1 | 6.5 | ◯ | |
| Example 19 | 3 | 7.0 | Δ | |
| | 6 | 7.8 | Δ | Δ |
| Example | 1 | 6.4 | ⊚ | |
| Embodiment | 3 | 6.6 | ⊚ | |
| 24 | 6 | 6.8 | ◯ | ◯˜⊚ |
| Example | 1 | 6.3 | ⊚ | |
| Embodiment | 3 | 6.4 | ⊚ | |
| 25 | 6 | 6.5 | ⊚ | ⊚ |

Nutmeg 20 g
Temperature: 40° C., Humidity: RH75%
⊚ Good, ◯ Average, Δ Slightly Poor, X Poor

Example embodiments 24 and 25 were confirmed to have the same preservability as the glass container. Accordingly, because dry solid food having a strong aroma such as spice and the like can be preserved and kept dry for a long period of time without the aroma escaping, the plastic container for dry solid food of the present invention can be said to be suitable as a container which is filled and packaged with these.

### EXAMPLE EMBODIMENTS FOR COMPARING THE PRESERVABILITY OF DRY FOOD (LAVER) OF CARBON FILM COATED CONTAINERS

The containers had a size of 430 ml (inner surface area excluding the cover portion was approximately 380 cm²). The container formed with a DLC film under the same conditions as the conditions of Example Embodiment 4 of Table 1 formed Example Embodiment 26 of Table 6, and in the same manner the container formed with a DLC film under the same conditions as the conditions of Example Embodiment 17 of Table 1 formed Example Embodiment 27 of Table 6. Further, in the same manner for the reference examples, the container formed with a DLC film under the same conditions as the conditions of Reference Example 12 of Table 1 formed Reference Example 20 of Table 6, and the container formed with a DLC film under the same conditions as the conditions of Reference Example 9 of Table 1 formed Reference Example 21 of Table 6. The evaluation method is as follows.

(1) Toasted laver which is available on the market was obtained. A product was selected as close as possible to the time directly after manufacturing and selling. Forty eight sheets of 8-Kiri size toasted laver were transferred to various containers, and the open portions were sealed by a laminated film of polyethylene and aluminum foil.

(2) Evaluations were carried out after the containers were kept in an air-conditioned chamber at 40° C.×75% RH for 3 months.

(3) With regard to texture, evaluations were carried out by a panel of five people after the seals were broken according to the following four rankings: ⊚ good, ◯ average, Δ slightly poor, poor.

(4) The containers used as reference examples were as follows. Packaging with a moistureproofing agent was based on the state of goods on the market. Namely, 48 sheets of 8-Kiri size toasted laver (total of 6 sheets, corresponding to 4 g/sheet×6=24 g) and 25 g of a moistureproofing agent (quicklime is the main component of packages for quicklime) were placed inside a container having the size external diameter φ 76 mm×140 mmH (capacity: 430 ml, 25 g of PET resin). Further, wide-mouthed PET containers (capacity: 430 ml, surface area excluding the cover portion: approximately 380 cm², 25 g of PET resin, and an average thickness of 0.25 mm) whose inner surfaces were not covered by a DLC film formed the reference examples. The example embodiments were made by forming a DLC film in the PET containers used for the reference examples. Table 6 shows the evaluation of a preservability test of laver for the plastic containers for dry solid food according to the present invention.

Blank Space Below

TABLE 6

| | Evaluation of | Water content | |
|---|---|---|---|
| | Texture | (%) | Overall Evaluation |
| Reference | X | 9.8 | X |
| Example 20 | | | |
| (Only PET) | | | |
| Reference | Δ | 8.2 | X˜Δ |
| Example 21 | | | |
| Example | ◯ | 6.6 | ◯ |
| Embodiment 26 | | | |
| Example | ⊚ | 5.4 | ⊚ |
| Embodiment 27 | | | |
| Pakage with | ⊚ | 4.8 | ⊚ |
| moistureproofing | | | |
| agent | | | |

48 Sheets of 8-kiri stored for 3 months in an air-conditioned chamber at 40° C. × 75% RH
⊚ Good, ◯ Average, Δ Slightly Poor, X Poor

Example embodiments 26 and 27 were confirmed to have the same preservability as the container packaged with the moistureproofing agent. Accordingly, because dry solid food such as toasted laver and the like which require more moistureproofing can be stored in a dry state over a long period of time, there is no loss of texture in the plastic container for dry solid food of the present invention. Therefore, the plastic container of the present invention can be said to be suitable as a container which is filled and packaged with these. Furthermore, because this makes it possible for there to be no need for a moistureproofing agent, it becomes unnecessary to separately provide a plastic container and a moistureproofing agent, whereby there is the result that the processing of the container after use also becomes easy.

1. A plastic container for dry solid food having a DLC (Diamond Like Carbon) film formed on the inner surfaces thereof, wherein the water vapor permeability is 0˜0.006 g/container/day, and the oxygen permeability is 0˜0.011 ml/container/day.

2. The plastic container for dry solid food described in claim 1, wherein the dry solid food is a dry powdered food having an average particle diameter of 50 μm˜3 mm and a water content less than or equal to 6%, or a dry solid food having a water content less than or equal to 6%.

3. The plastic container for dry solid food described in claim 2, wherein the dry powdered food is instant coffee, spice or powdered milk.

4. The plastic container for dry solid food described in claim 2, wherein the dry solid food is dried laver.

5. The plastic container for dry solid food described in any one of claims 1˜4, wherein the plastic container is formed by polyethylene terephthalate resin.
